(19) United States
(12) Patent Application Publication
(10) Pub. No.: US 2006/0045144 A1
(43) Pub. Date: Mar. 2, 2006

(54) Diode laser array beam homogenizer

(75) Inventors: Scott R. Karlsen, Battle Ground, WA (US); Trevor Radley Crum, Vancouver, WA (US)

Correspondence Address: PATENT LAW OFFICE OF DAVID G. BECK, P. O. BOX 1146, MILL VALLEY, CA, 94942, US

(73) Assignee: nLight Photonics Corporation, Vancouver, WA (US)

(21) Appl. No.: 10/932,719

(22) Filed: Sep. 1, 2004

(51) Int. Cl. H01S 3/10

(52) U.S. Cl. 372/9; 372/98

(57) ABSTRACT

A means of achieving a spatially uniform output beam from a laser diode array with minimal design complexity is provided. The means is comprised of one or more optical elements located adjacent to the output of the diode array, the optical element(s) reducing the divergence of the output of the individual emitters of the diode array in at least one axis to within an acceptable range, preferably within the range of 0.1 to 10 degrees. The means is further comprised of a diffusing element, the output of the emitters passing through the optical element(s) prior to passing through the diffusing element. The diffusing element, preferably either a holographic diffuser or an engineered diffuser™ which provides control over the light diffusion angles, smoothes out the ripples formed by the overlapping output beams of the emitters in order to achieve the desired spatially uniform beam.

### FIELD OF THE INVENTION

The present invention relates generally to diode lasers and, more particularly, to a method and apparatus for improving the uniformity of the output beam of a diode laser array.

### BACKGROUND OF THE INVENTION

Solid state lasers have proven useful in a variety of applications. Their usefulness, however, is often limited by the achievable mode quality and beam stability. Additionally, beam non-uniformities are often the source of system problems ranging from non-uniform illumination of the intended target (e.g., photolithography systems) to potential damage of system components (e.g., gain medium, optics) due to beam hot spots.

Although solid state lasers can be pumped with a number of different types of sources, diode laser pumps have proven advantageous for a variety of reasons. First, ultra compact systems are achievable using diode laser pumps. Second, diode laser pumps can be selected on the basis of their output spectrum, thus allowing the selection of a pump source which is efficiently absorbed by the solid state laser medium. Third, due to the efficiency of diode lasers, the overall efficiency of diode pumped solid state lasers is typically much higher than that of flashlamp pumped solid state lasers. Fourth, relatively simple optical systems can be devised to couple the pump output into the laser medium. For example, as opposed to the complexity of a flash lamp enclosed pump cavity designed to maximize the capture efficiency (based on cavity shape, separation of source and medium, etc.) and transmission efficiency (based on chamber wall reflectivity, reflection losses, absorption losses in the coolant fluid, etc.), diode pumps can be used in simple end-pumped or side-pumped configurations, often with the use of minimal, if any, intervening optics.

A variety of methods have been devised to improve the coupling efficiency between a diode pump laser and the pump medium as well as the overall performance of the combined system. For example, U.S. Pat. No. 5,307,365 discloses a pumping configuration in which the pump beam generated by a diode laser array passes through a collimating lens (e.g., a cylindrical optical fiber) and a focusing lens (e.g., a plano-convex lens) before entering a highly transparent injection port of a highly reflective optical cavity housing the solid state laser rod. The optics associated with the diode laser array reduce the divergence of the diode pump laser, thus allowing the injection port to be extremely narrow, for example on the order of 100 to 200 microns. The reflective optical cavity insures that light that is not absorbed during a first pass through the laser rod is reflected within the cavity until it is absorbed.

U.S. Pat. No. 6,700,709 discloses beam shaping optics for use with a diode array (i.e., diode bar), the beam shaping optics allowing efficient coupling of the output beam into an optical fiber. The beam shaping optics includes a beam inversion optic based on arrays of graded index optics, cylindrical Fresnel lenses, reflective focusing optics or a general optical system. The beam shaping optics have a magnification equal to −1, the intent being to maximize the output brightness of the diode array. The patent discloses that prior to the beam inversion optic, the fast axis of the individual emitters of the diode array can be collimated with a single cylindrical lens. Additionally the slow axis of the individual emitters can also be collimated.

U.S. Pat. No. 6,738,407 discloses a solid state laser rod pumping system that uses beam focusing optics and a beam guiding component to efficiently couple the output of a diode laser array into the lasing medium. In at least one disclosed embodiment, the beam focusing optics are constructed using the combination of a cylindrical lens array to collimate the incident light and an aspheric lens to focus the collimated light to a linear cross-section. The beam guiding component directs the light from the beam focusing optics toward the laser rod which is housed within a diffusive reflection tube.

Although a variety of optical systems have been designed to more efficiently utilize the output from a diode laser array, these systems typically are complex, difficult to manufacture, and designed to meet the requirements of a specific application. Accordingly, what is needed in the art is a relatively simple, easy to manufacture optical system that provides a spatially uniform beam from a diode laser array that can be used in a variety of applications. The present invention provides such an optical system.

### SUMMARY OF THE INVENTION

The present invention provides a means of achieving a spatially uniform output beam from a laser diode array with minimal design complexity. The means is comprised of one or more optical elements located adjacent to the output of the diode array, the one or more optical elements reducing the divergence of the output of the individual emitters of the diode array to within an acceptable range, preferably within the range of 0.1 to 10 degrees. In at least one embodiment the optical element(s) reduces the divergence in one axis (e.g., the fast axis) of each of the emitters while having negligible impact on the divergence in the other axis (e.g., the slow axis). In at least one other embodiment the optical element(s) reduces the divergence in both axes. The means is further comprised of a diffusing element, the output of the emitters passing through the optical element(s) prior to passing through the diffusing element. The diffusing element, preferably either a holographic diffuser or an engineered diffuser™ which provides control over the light diffusion angles, smoothes out the intensity variations (i.e., ripples) formed by the overlapping output beams of the emitters in the near field, thus achieving the desired spatially uniform beam.

A further understanding of the nature and advantages of the present invention may be realized by reference to the remaining portions of the specification and the drawings.

### BRIEF DESCRIPTION OF THE DRAWINGS

FIG. 1 is an illustration of a diode laser array and a conventional optical system according to the prior art;

FIG. 2 is an illustration of the profile of the output from the diode laser array/optical system shown in FIG. 1;

FIG. 3 is an illustration of the diode laser array of FIG. 1 coupled to an optical system that provides for controlled expansion of the individual beams;

FIG. 4 is an illustration of the profile of the output from the diode laser array/optical system shown in FIG. 3, measured at a location relatively close to the array/optical system;

FIG. 5 is an illustration of the profile of the output from the diode laser array/optical system shown in FIG. 3, measured at a location relatively distant from the array and optical system; and

FIG. 6 is an illustration of a diode laser array and an optical system in accordance with the invention; and

FIG. 7 is an illustration of a diode laser array and an alternate optical system in accordance with the invention.

### DESCRIPTION OF THE SPECIFIC EMBODIMENTS

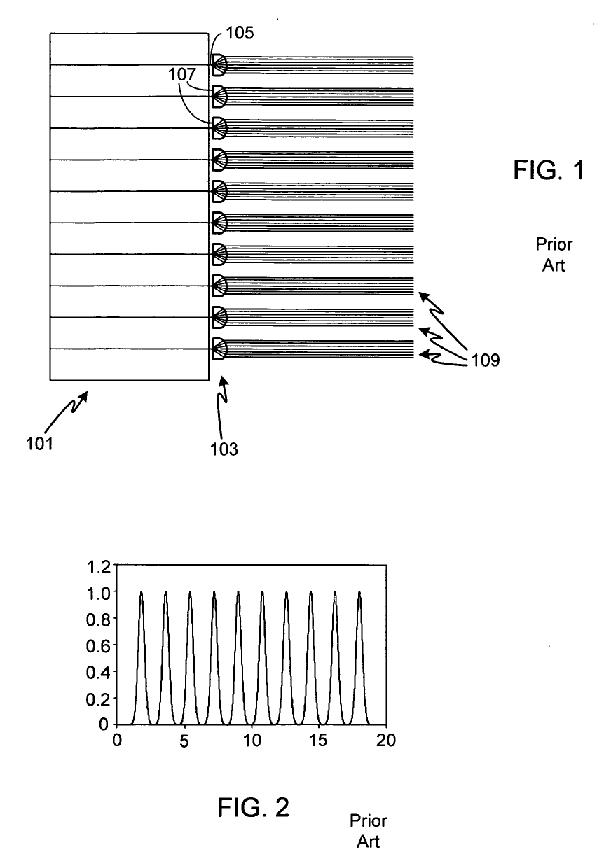

FIG. 1 is an illustration of a diode laser array 101 (e.g., a diode laser bar or stack) and a conventional optical system 103, system 103 providing improved beam uniformity. As shown, each output beam 105 from laser diode array 101 passes through an optical element 107 of optical system 103, thereby forming a plurality of collimated output beams 109. FIG. 2 illustrates the beam profile of the output of laser array 101 after the output beams have passed through optical system 103. As shown, the output profile consists of a plurality of discrete beams.

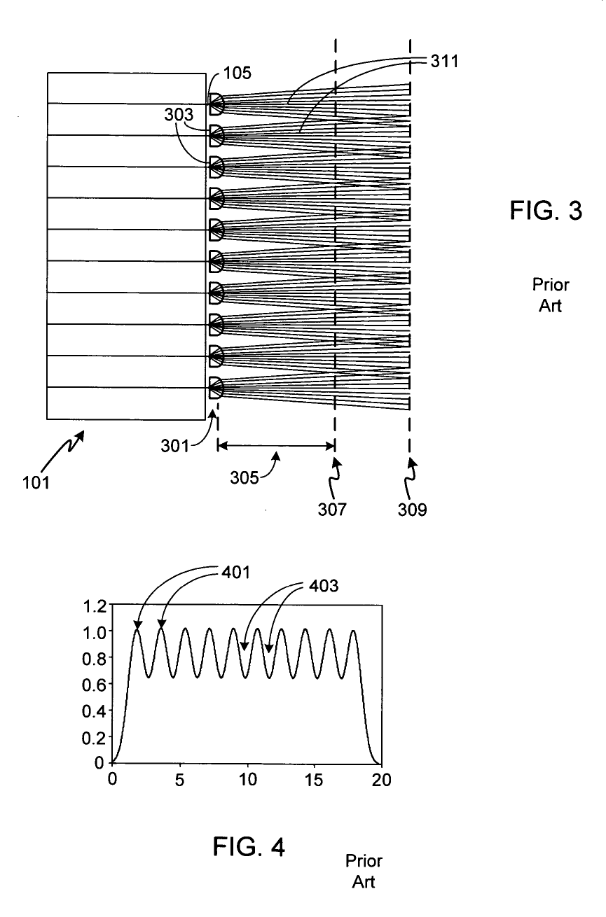

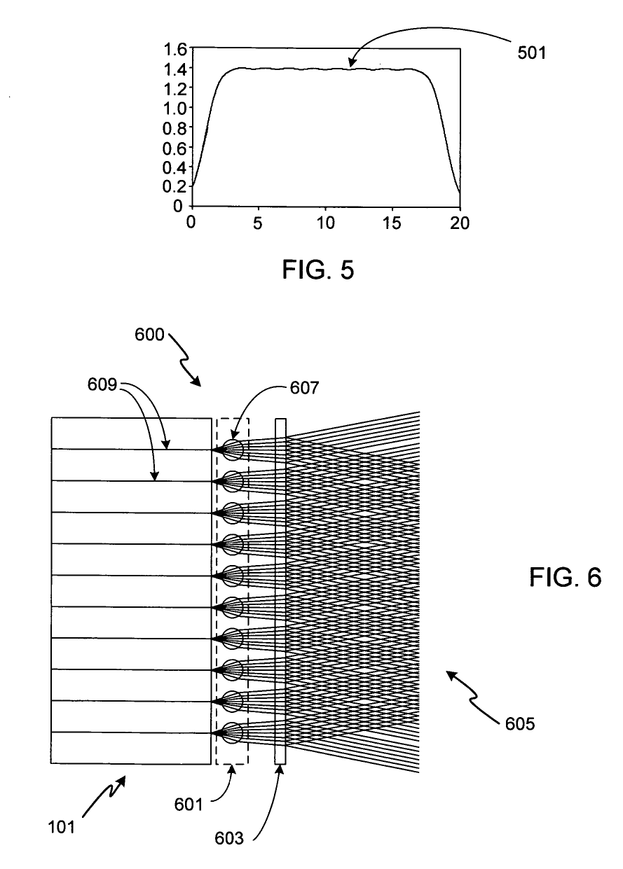

FIG. 3 is an illustration of diode laser array 101 passing through a optical system 301, system 301 intended to provide a more uniform output than that provided by optical system 103. As shown, the effect of each element 303 of optical system 301 is to control the expansion of beams 105 such that they overlap as the distance 305 between optical system 301 and the measurement location 307 is increased. Assuming a measurement location 307 relatively close to optical system 301, the output profile will consist of a plurality of peaks 401 and valleys 403 as shown in FIG. 4. Given a sufficient distance 305 between optical system 301 and the measurement location, for example at a location 309, and assuming that the individual output beams 311 are perfectly Gaussian, a highly uniform output beam 501 is achievable (FIG. 5).

Although the system illustrated in FIG. 3 achieves the goal of a uniform beam from a diode laser array, it requires that optical system 301 either be comprised of collimating lenses with very short focal lengths or comprised of aspheric lenses designed to achieve the desired beam expansion. Unfortunately suitable small focal length lenses are typically very small and fragile, making their mounting difficult. Aspheric lenses, although easier to mount, tend to be quite expensive to design and manufacture.

In order to overcome the afore-mentioned problems while still achieving the desired beam uniformity, the optical system of the present invention uses one or more divergence reducing optical elements in combination with a beam diffusing element. The beam divergence reducing optical element(s) reduces the divergence within one or both axes of each emitter to a level below the desired level while the beam diffusing element increases the divergence to the desired level while simultaneously eliminating the intensity ripples of the output beam.

The degree to which the divergence reducing optical element(s) reduces the beam divergence of each emitter of the array depends on the desired overall system configuration, the desired beam collimation, the orientation of the individual emitters of the array, and the distance between the output facets of array and the divergence reducing optical element(s). With respect to the desired beam collimation, some optical systems require a specific beam divergence. For example, the optical system may include a wavelength selective feedback element(s) prior to the diffusing element. Typically in such systems the beam from the array must be collimated before impinging on the feedback element(s), thus insuring that the reflected feedback is coupled back into the array. The present invention then operates on the post-feedback element beam to achieve the desired divergence and beam uniformity.

The inventors of the present invention have found the primary usefulness of the invention to be those applications in which the desired divergence is less than 10°, and preferably in the range of 0.1° to 10°. Accordingly the divergence reducing optical element(s) of the present invention preferably reduces the divergence of the emitters in one or both axes to fall within the range of 0.1° to 10°.

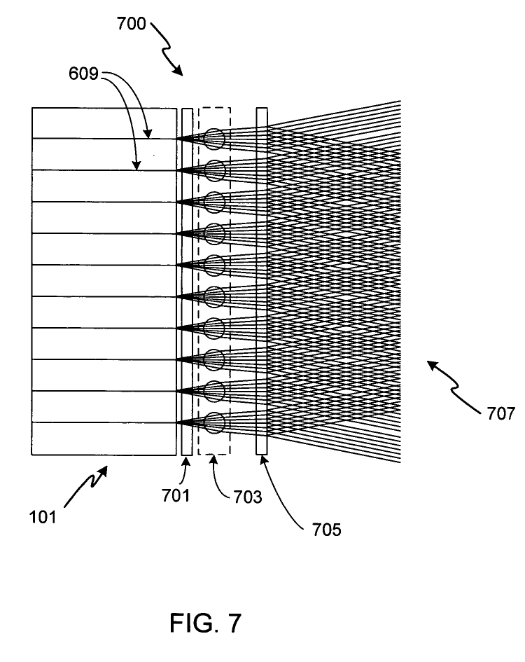

In one embodiment, the invention uses a single divergence reducing element, for example element 601 of FIG. 6. Typically element 601 reduces the divergence of the output from the individual emitters in a first axis (e.g., the fast axis) while having negligible effect on the divergence in a second, orthogonal axis (e.g., the slow axis). In an alternate embodiment, element 601 reduces the divergence of the output from the individual emitters in both a first axis (e.g., the fast axis) and the second axis (e.g., the slow axis), although typically to different degrees. In an alternate embodiment, two or more divergence reducing elements are used. For example as shown in FIG. 7, a pair of elements 701 and 703 are used to reduce the divergence in the two axes of the individual emitters to the desired levels.

Any of a variety of optical elements can be used for element 601 of FIG. 6 and for elements 701 and 703 of FIG. 7. For example, cylindrical lenses (e.g., an optical fiber), microlens arrays (e.g., an array of cylindrical lenses), aspheric cylindrical lens arrays, etc. can be used in the invention. When an array of lens elements is used, typically each lens elements corresponds to a single emitter of the array, thus acting only on the divergence of the corresponding emitter. Preferably when a pair of optical elements is used as in FIG. 7, the combination of a single lens acting on all emitters (e.g., lens 701) and an array of lens elements (e.g., lens array 703) acting on the corresponding individual emitters is used. As the design of such lenses and lens arrays are well known by those of skill in the art, further description will not be provided herein.

After the divergence of the emitters has been reduced to the desired level, preferably in the range of 0.1° to 10°, a beam diffusing element is used, i.e., element 603 of FIG. 6 and element 705 of FIG. 7. Common diffusers with near Lambertian scattering (e.g., opal glass, ground glass) will not work at this divergence level. Accordingly diffusing element 603, or element 705, is one that functions at this divergence level and allows the direction of the diffused light to be controlled, thus allowing a uniform output beam to be formed (e.g., beam 605 from system 600 and beam 707 from system 700). Suitable diffusers include holographic diffusers, such as those manufactured by Physical Optics Corporation of Torrance, Calif., and engineered diffusers™ (e.g., lenticular diffusers).

As shown in the example embodiment of FIG. 6, the individual lens elements 607 of optical element 601 reduce the divergence of emitters 609 to the desired range while diffusing element 603 smoothes out the ripples resulting from the overlapping of the individual light beams. In the example embodiment of FIG. 7, lens 701 reduces the divergence of emitters 609 in a first axis, lens array 703 reduces the divergence of emitters 609 in a second axis, and diffusing element 705 smoothes out the intensity ripples in the output beam. As a result, output 605 and output 707 are similar to that shown in FIG. 5, but without the need for expensive lenses, complex mounting configurations, etc. An additional benefit of the invention is that diffusing element 603 (or diffusing element 705) can also act as a protective window for the device as this is the outermost element of device 600 (or device 700).

Although device 600 (or 700) is ideally suited as a pump source for a solid state laser, it will be appreciated that the present invention is not limited to such applications, rather it is useful with any application where a spatially uniform beam from a diode laser array is desired.

As will be understood by those familiar with the art, the present invention may be embodied in other specific forms without departing from the spirit or essential characteristics thereof. For example, the invention is not limited to a specific type of diffuser as long as the selected diffuser is sufficiently transmissive and allows the system and/or optical designer control over the diffusion angles. Also, the invention is not limited to a specific divergence reducing optical element, as long as the optical element reduces the divergence to within the desired range. Accordingly, the disclosures and descriptions herein are intended to be illustrative, but not limiting, of the scope of the invention which is set forth in the following claims.

What is claimed is:

1. A laser system comprising:
a diode laser array comprised of a plurality of emitters, wherein each of said plurality of emitters emits an output beam from an output facet;
an optical element adjacent to said output facets of said plurality of emitters of said diode laser array, said optical element reducing beam divergence in at least a first axis of said output beams of said plurality of emitters; and
a diffusing element adjacent to an output side of said optical element.

2. The laser system of claim 1, wherein said optical element reduces said beam divergence in said at least said first axis to within a range of 0.1 to 10 degrees.

3. The laser system of claim 1, wherein said optical element is a cylindrical lens.

4. The laser system of claim 1, wherein said optical element is an aspheric cylindrical lens.

5. The laser system of claim 1, wherein said optical element is comprised of a plurality of lens elements, said plurality of lens elements corresponding to said plurality of emitters.

6. The laser system of claim 5, wherein said plurality of lens elements is comprised of a plurality of cylindrical lenses.

7. The laser system of claim 1, wherein said optical element is comprised of a first beam divergence reducing element and a second beam divergence reducing element.

8. The laser system of claim 7, wherein said first beam divergence reducing element reduces the divergence of said plurality of emitters in a first axis and said second beam divergence reducing element reduces the divergence of said plurality of emitters in a second axis.

9. The laser system of claim 7, wherein said first beam divergence reducing element is a cylindrical lens and said second beam divergence reducing element is a microlens array wherein each microlens of said microlens array corresponds to an individual emitter of said plurality of emitters.

10. The laser system of claim 1, wherein said diffusing element is a holographic diffuser.

11. The laser system of claim 1, wherein said diffusing element is an engineered diffuser™.

12. The laser system of claim 11, wherein said engineered diffuser™ is a lenticular diffuser.

13. A method of achieving a spatially uniform beam from a diode laser array comprising the steps of:
reducing divergence in at least a first axis of each of a plurality of output beams from said diode laser array to within a range of 0.1 to 10 degrees;
diffusing each of said plurality of output beams after said divergence reducing step; and
overlapping said plurality of output beams after said diffusing step to form said spatially uniform beam.

14. The method of claim 13, wherein after said divergence reducing step divergence in said first axis and a second, orthogonal axis of each of said plurality of output beams is within the range of 0.1 to 10 degrees.
